(19) United States
(12) Patent Application Publication
(10) Pub. No.: US 2010/0139206 A1
(43) Pub. Date: Jun. 10, 2010

(54) BELOW FLOOR MARKER

(76) Inventor: Joe T. Minarovic, Georgetown, TX (US)

Correspondence Address: LAW OFFICE OF JACK V. MUSGROVE, 2911 BRIONA WOOD LANE, CEDAR PARK, TX, 78613, US

(21) Appl. No.: 12/330,122

(22) Filed: Dec. 8, 2008

(51) Int. Cl. G01V 15/00

(52) U.S. Cl. 52/745.2; 52/103

(57) ABSTRACT

A below floor marker used to locate a pre-installed pipe stub below a finished concrete floor includes a coupling adapted for attachment to the pipe stub, and a cap which fits on the coupling to seal the pipe while pouring the concrete. The top wall of the cap lies an inch or so under the finished floor elevation (FFE). The cap has resilient filaments at a center thereof extending through the thin concrete layer to provide a visual indication of the pipe stub location. An electronic marker is retained within the coupling to provide an additional electromagnetic indication of the pipe stub location. The transmission axis of the electronic marker is aligned with the centerline of the cap/conduit/pipe to provide precise location of the stub. The cap may include an upper sidewall having outer annular notches which facilitate cutting the upper sidewall to a height of the FFE.

### BACKGROUND OF THE INVENTION

1. Field of the Invention

The present invention generally relates to the installation of utility delivery systems during construction of houses or buildings, and more particularly to a method and system for precisely locating an end portion or stub of a utility conduit just below the surface of a concrete floor.

2. Description of the Related Art

Concrete has been used as a permanent surfacing material for building floors since the early 1800's. The need developed soon thereafter to permanently place utility conduits in concrete floors for water, sewer and other utility delivery systems for the buildings. Conduits such as steel or polyvinylchloride (PVC) piping are pre-installed prior to making the concrete floor, and are held in place by various means so they remain subsurface after the concrete is poured and cured, except for a stub portion of the pipe which may extend above the floor for pressure testing. Consumer fixtures are thereafter attached to the pipe stubs.

The practice of pre-installing PVC and steel pipe stubs presents problems in producing a uniform, glass-like finish of the concrete surface. Any feature protruding from the floor makes it much more difficult to achieve a flat grade using powered troweling equipment. It is also necessary for tilt-wall building construction to provide 100% clear floor space, i.e., smooth and level with no protruding features, because the tilt walls are poured in place horizontally on the floor as a base prior to being tilted to their upright positions.

It has accordingly become common practice to cut pipe stubs slightly below the floor line and cover them for concrete installation. Thereafter, the thin layer of concrete overlying the protective cover is broken or chipped away and removed, providing access to the embedded pipe. It can, however, be problematic to find the subsurface pipe stubs even with blueprints indicating their locations, so various means have been devised to assist in locating such capped conduits.

U.S. Pat. No. 4,915,055 discloses two embodiments of a protective cover advantageously provided with a conduit locator feature which includes a plurality of springy plastic rods. The rods extend upwardly through the poured concrete floor to provide a visual indication of the location of the end of the conduit.

Another cap design is described in U.S. Pat. No. 5,003,735. That marker screw cap seals the end of a duct, and similarly marks the location using upwardly-extending resilient fibers.

U.S. Pat. No. 5,044,303 shows another subsurface conduit marking apparatus which wraps around the end of a pipe stub and has several strips of flexible material that extend vertically above the surface of the poured concrete floor. The strips may be color-coded, and the cover may be Styrofoam to facilitate break out of the concrete.

These caps are useful for locating the pipe or duct stub provided that the visual indicators (rods, strips, filaments) are properly installed on the cap, and further assuming that they remain intact. It is easy, however, to inadvertently break off these members from the cap, for example using powered troweling equipment which can shear the upwardly-extending filaments at the surface, making it difficult or impossible to detect by visual means. For those prior art caps wherein the filaments are located around the periphery or circumference of the stub, if most of the filaments are broken away leaving only 1 or 2 it is impossible to tell where the center of the subsurface conduit stub is located, and covered by the thin layer of concrete. The concrete floor could be damaged when the craftsman hammers on the wrong side of the visual indicators where the concrete is solid.

In light of the foregoing it would be desirable to devise an improved method and system for locating conduit stubs which are just below the surface of a concrete or similar floor. It would be further advantageous if the method and system could precisely locate the center of the subsurface conduit stub.

### SUMMARY OF THE INVENTION

It is therefore one object of the present invention to provide an improved method of locating subsurface pipe stubs embedded in a concrete floor.

It is another object of the present invention to provide a marker cap to locate such pipe stubs which is locatable by other than visual means.

It is yet another object of the present invention to provide a below floor marker which can precisely locate the center of a subsurface conduit stub.

The foregoing objects are achieved in an article for marking a pre-installed conduit below a flooring surface such as concrete, generally comprising a coupling having a first end adapted for attachment to an end of the conduit, a cap adapted for attachment to a second end of the coupling, and an electronic marker retained inside the coupling having a transmission axis aligned with a common longitudinal centerline of the coupling and cap. The cap preferably has resilient filaments proximate a center thereof which extend upwardly through the concrete. The electronic marker may be attached to an underside of a top wall of the cap or, alternatively, a removable retainer which fits against an inner wall of the coupling or conduit under expansive tension may be used to hold the electronic marker. In the illustrative embodiment the electronic marker is a passive resonant marker, and can be either elongate and vertically-disposed, or disk-shaped and horizontally disposed. In another embodiment the cap includes an upper sidewall having a plurality of annular notches formed along an outer surface thereof to facilitate cutting the cap to a desired height. The top wall may further have an upper surface with a notch to facilitate cutting and removal of a portion of the top wall.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a perspective view of one embodiment of the below floor marker system of the present invention wherein a cap having an elongate electronic marker and upwardly extending filaments fits over a pipe coupling;

FIG. 2 is a cross-sectional side view of the below floor marker system of FIG. 1 installed on a pipe stub;

FIG. 3 is a perspective view of another embodiment of the below floor marker system of the present invention wherein a cap having upwardly extending filaments fits over a pipe coupling which separately retains an elongate electronic marker;

FIG. 4 is a cross-sectional side view of the below floor marker system of FIG. 3 installed on a pipe stub;

FIG. 5 is a top plan view of the pipe coupling of FIG. 3 with the electronic marker and retaining feature;

FIG. 6 is a side view of yet another embodiment of the below floor marker system of the present invention wherein a cap having a flat, circular electronic marker fits over a pipe coupling, and the top of the cap has a series of annular score marks to facilitate cutting the top at particular height based on the finished floor elevation;

FIG. 7 is a perspective view illustrating the locating of the below floor marker using a electronic transceiver.

The use of the same reference symbols in different drawings indicates similar or identical items.

### DESCRIPTION OF THE PREFERRED EMBODIMENT(S)

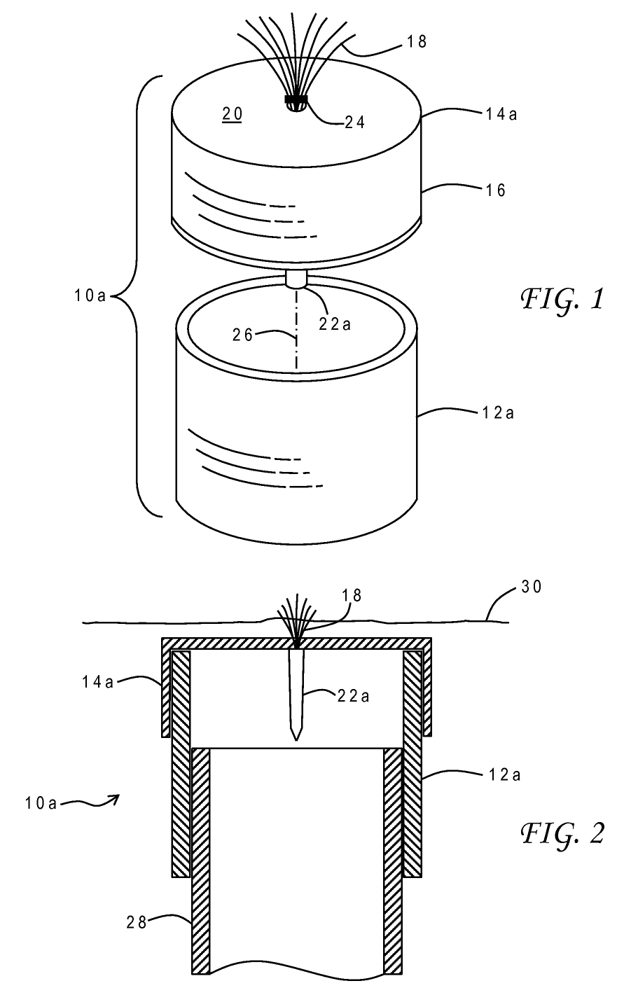

With reference now to the figures, and in particular with reference to FIG. 1, there is depicted one embodiment 10a of a below floor marker system constructed in accordance with the present invention. Below floor marker system 10a is generally comprised of a coupling 12a and a fitting or cap 14a that fits on top of coupling 12a. Coupling 12a is adapted for attachment to a conduit such as a pipe or duct stub that delivers a utility service to a building or house (e.g., water, wastewater, natural gas, ventilation, electricity, optical fibers, etc.). The size and shape (cross-section) of coupling 12a generally conforms to the size and shape of the particular conduit, so different below floor marker systems may be provided for different sizes/shapes of various pipes or ducts. Coupling 12a may include threading, ribs, detents, or other attachment features along its inner surface or outer surface in other embodiments which secure coupling 12a, releasably or fixedly, to the conduit stub.

Cap 14a has a size and shape to match coupling 12a so, for the depicted embodiment, it is generally cylindrical and its inner diameter is approximately equal to the outer diameter of coupling 12a whereby its side wall 16 provides a tight friction fit about coupling 12a when installed to seal off the end of the conduit. In an exemplary embodiment for 4″ pipe (e.g., schedule 40 PVC) coupling 12a has an inner diameter of 4½″, an outer diameter of 5″, and is 4″ tall; cap 14a has an inner diameter of 5″, a height of 2″, and a thickness of 0.03″. In alternative embodiments the inner surface of side wall 16 includes an attachment feature which mates with a corresponding feature on the outer surface of coupling 12a. In further alternative embodiments the outer surface of side wall 16 may attach to the inner surface of coupling 12a, but it is preferable to keep the inner diameter of the pipe open and clear to facilitate attachment of the building fixture (toilet, faucet, electrical box, etc.) to 12a coupling. In lieu of mechanical fastening, cap 14a may be secured to coupling 12a by adhesive bonding, solvent welding, ultrasonic welding, fusion bonding, etc. As with coupling 12a, different caps 14a may be provided with different sizes/shapes (e.g., rectangular) according to the particular pipe or duct involved. Alternatively, the lower portion of coupling 12a may have a cross-section which conforms to the conduit stub while the upper portion of coupling 12a is a consistent shape such as circular so that only one design for cap 14a is necessary.

Cap 14a has a plurality of resilient filaments 18 extending outwardly from its top wall 20, and an elongate electronic marker 22a disposed along the common longitudinal centerline 26 of coupling 12a and cap 14a. Electronic marker 22a may be fixed to the underside of top wall 20, or attached whereby it freely pivots or hangs in vertical orientation regardless of minor deviations in the level of top wall 20. In one embodiment filaments 18 are attached to the upper end of electronic marker 22a and pass through a hole formed at the center of top wall 20, retained by a band or ring 24 wrapped around the base of the filaments on the outer side of top wall 20.

Below floor marker system 10a is shown installed on a pipe 28 in the cross-sectional side view of FIG. 2. Pipe 28 may for example be made of steel or polyvinylchloride (PVC). The lower portion of coupling 12a is attached to pipe 28, and cap 14a rests atop the upper portion of coupling 12a. Top wall 20 of cap 14a is preferably located about 1″ below the concrete surface 30, i.e., finished floor elevation (FFE). While the invention is particularly suited for concrete floors, it is equally applicable to other types of flooring materials that are applied after pre-install of conduits, such as polymer concrete, rubber materials, epoxy resins, and other synthetic compounds.

Filaments 18 extend upwardly through the thin layer of concrete overlying cap 14a, and visually mark the precise center of the conduit stub. Electronic marker 22a is likewise positioned along the longitudinal centerline of the conduit stub. Electronic marker 18 may be based on a variety of electronic marker designs, e.g., active markers, passive markers, smart markers (radio-frequency identification), etc. In this embodiment electronic marker 22a is a passive resonant marker constructed by winding a wire coil about an elongate ferrite core and connecting the ends of the wire to pins of a capacitor forming a resonant (LC) circuit. The body of electronic marker 22a is 4″ long with a diameter of 0.625″. The axis of the ferrite core marker (i.e., the axis of the wire coil and ferrite cylinder) is generally parallel with the axis of the elongate marker body, vertical and aligned with the centerline of the conduit when installed as shown in FIG. 2. In this manner electronic marker 22a also precisely marks the center of the conduit stub. The passive marker may be tuned to a specified frequency using known techniques; the frequency may correspond to a particular type of utility service according to industry conventions, e.g., 83.0 kHz for gas, 101.4 kHz for telephone, 121.6 kHz for sewage, 145.7 kHz for water, and 169.8 kHz for power. Electronic marker 22a may be located after concrete installation using a conventional transceiver locator which sends an electromagnetic signal into the floor at the resonant frequency to energize the passive marker during an activation phase, and then receives the echo signal from the passive marker during a listening phase.

Coupling 12a and cap 14a may be formed from any durable materials, preferably polymeric. In a preferred embodiment coupling 12a is constructed of PVC or acrylonitrile butadiene styrene (ABS), and cap 14a is constructed of a low surface adhesion material such as low-density polyethylene. Cap 14a and/or coupling 12a may optionally be color-coded according to industry conventions for the particular type of utility service, or otherwise labeled with such information. Filaments 18 preferably are made out of polypropylene and extend 4″ from the upper surface of cap 14a. The below floor marker system of the present invention may omit the filaments and still provide accurate electromagnetic location of the pipe stub via the electronic marker.

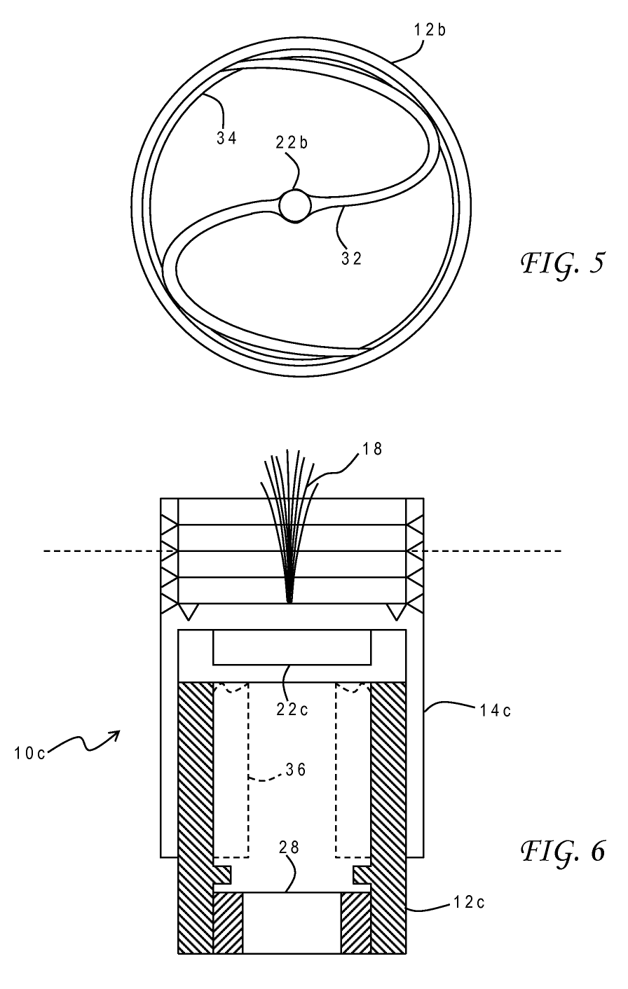

Referring to FIGS. 3-5, in a variation of the present invention shown as below floor marker system 10b, the electronic marker is now attached to the coupling instead of being attached to the cap. A strip of flexible material forming a retainer 32 is placed within coupling 12b. Retainer 32 may be a generally rectangular strip constructed of high-density polyethylene which is flexed into an S-shape (S-spring) to fit under expansive tension within coupling 12b. Retainer 32 has cutouts near its center which receive electronic marker 22b and maintain it in a generally vertical orientation when located in a vertically-disposed coupling. The use of a flexible retainer removes any requirement for the retainer to have exact dimensions matching the coupling or pipe, so a single retainer can be used for a variety of conduit sizes. For this embodiment coupling 12b preferably has an annular flange 34 along its inner wall, seen in the top plan view of FIG. 5, which abuts against the lower edge of retainer 32 to prevent the retainer from being pushed too far down the coupling. Electronic marker 22b is again a ferrite-core passive marker. Filaments 18 are adhered to or embedded in the top wall of cap 14b.

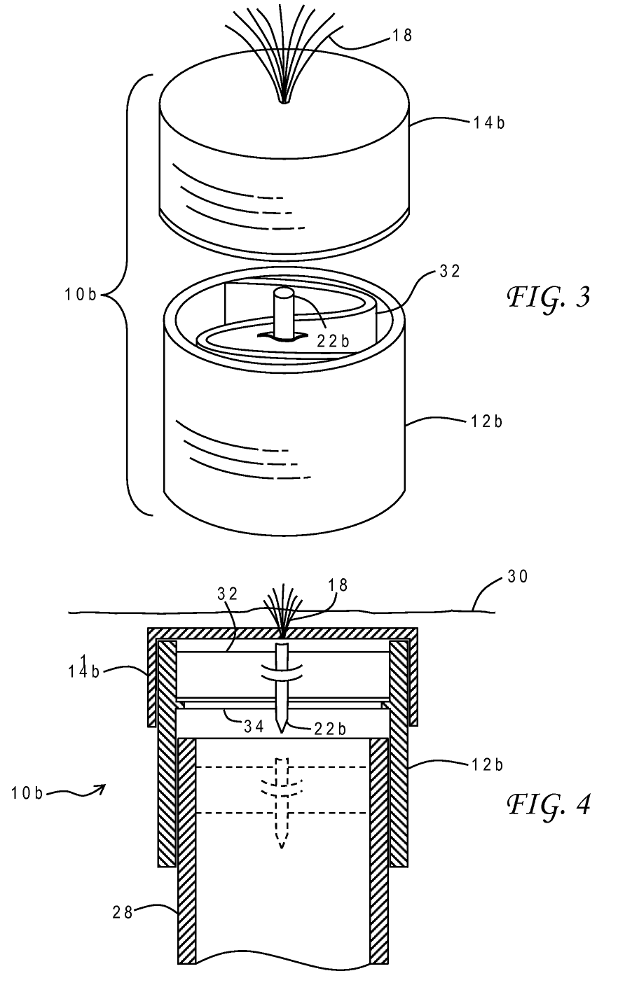

Below floor marker system 10b is shown installed on a pipe 28 in the cross-sectional side view of FIG. 4. Filaments 18 and electronic marker 22b again precisely mark the center of the conduit stub. In an alternate deployment retainer 32 and electronic marker 22b are placed inside of the pipe stub, centered. After the pipe stub has been located using below floor marker system 10b, retainer 32 and electronic marker 22b are removed and can easily be reused in another system.

The size of retainer 32 depends on the implementation. For a coupling having an inner diameter of 4½″, retainer 32 is 12″ long and 1½″ wide, with a thickness of 0.06″. In the illustrated embodiment there are two portions or vanes of retainer 32 that extend outward to engage the coupling surface, but the shape and design of retainer 32 may vary in alternative embodiments and include additional vanes for example forming a pinwheel design. In further embodiments retainer 32 may be hemispherical or conical with the apex of the shape extending downward and having a hole to receive the electronic marker, or have a C-shape (C-spring) with a central extension to support the electronic marker. While a flexible retainer is preferred to simplify installation, the retainer could alternatively utilize rigid, adjustable members to engage the inner surface of the coupling.

Another embodiment 10c of the below floor marker system of the present invention is shown in cross-section in FIG. 6. Below floor marker 10c includes a coupling 12c and a cap 14c. Coupling 12c is installed on a pipe stub 28. Cap 14c includes filaments 18 and an electronic marker 22c, but in this embodiment electronic marker is disk-shaped, i.e., generally flat and circular. Electronic marker 22c is still a passive marker with a wire coil whose axis is vertically aligned when cap 14c is installed on a vertically-disposed coupling 12c, i.e., the body of marker 22c is horizontally disposed. The transmission axis coincides with the centerline of the body of electronic marker 22c, and the body is centered with cap 14c so that the peak signal transmission again occurs precisely at the center of pipe stub 28.

Cap 14c has a lower sidewall which engages coupling 12, and an upper sidewall having a plurality of annular score lines or notches along the outer surface thereof. These notches facilitate cutting of the upper sidewall to adjust the height of cap 14c to the planned finished floor elevation. In an exemplary embodiment the upper sidewall extends 2″ above the top wall of cap 14c, and four notches are formed at intervals of ¼″. Another circular notch is formed in the top wall of cap 14c along its inner periphery, to facilitate knocking out the top wall for installation of the new facility 36. To further facilitate the determination of the proper height of the upper sidewall of cap 14c, the outer surface thereof may be coated or covered with a photosensitive or heat-sensitive material such as dry X-ray film which reacts to light from a laser level used to reckon the FFE and thereby forms a marking or pattern on the outer surface of the upper sidewall indicating the cut line.

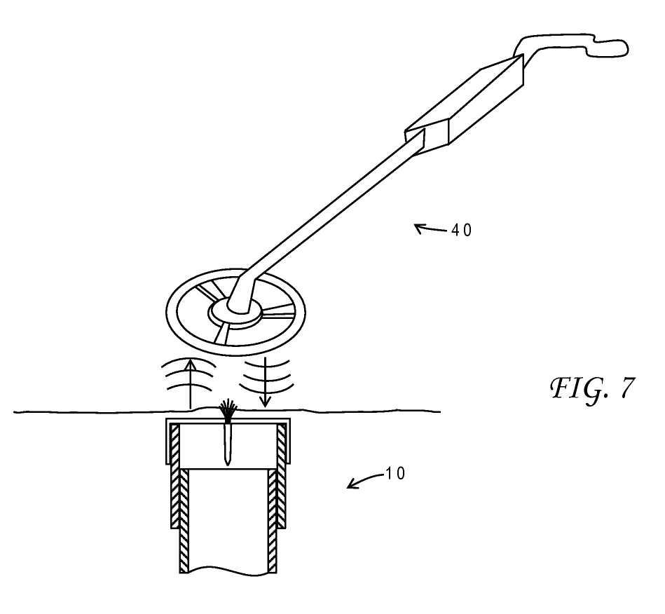

Any of the foregoing embodiments may be used to advantageously mark the location of pre-installed conduits with precision and reliability. After the concrete or other floor finishing material is applied, electronic marker 22 may be located as illustrated in FIG. 7 using a transceiver locator 40 which sends an electromagnetic signal into the ground at the resonant frequency to energize the passive marker during an activation phase and then receives the echo signal from the passive marker during a listening phase. Other electronic receivers may be used depending on the type of electronic marker employed. The electromagnetic locating ability allows quick pinpointing of the desired conduit even if the filaments have been removed. Conversely, if electronic marker 22 is defective or a transceiver locator is not available, the location of the conduit may be determined visually by means of the filaments. The flexible plastic cap placed over the coupling provides a template for hammering out an opening in the concrete to reveal the cap. The top wall of the cap is then shaved off or cut out and removed. The top wall may be constructed of a frangible material to ease removal, such as acrylonitrile butadiene styrene. In an alternative embodiment the top wall is a removable section of the cap secured by, e.g., threaded or twist/lock engagement with the side wall. The cap is designed to provide a dimensional clearance sleeve for the coupling and a conduit riser for easy vertical installation in the coupling. The conduit riser may be affixed to the coupling by a variety of methods previously described for attaching the coupling to the pipe stub. Below floor marker 10 may be used in conjunction with other locating means such as a plan template of the floor or global positioning system (GPS) coordinates.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, while the below floor marker system has been described as including both the cap and conduit, the conduit may be integrated with the cap or omitted for certain applications wherein the cap fits directly on the pipe stub, either with the electronic marker attached to the cap or retained within the pipe stub. It is therefore contemplated that such modifications can be made without departing from the spirit or scope of the present invention as defined in the appended claims.

What is claimed is:

1. A method of marking a pre-installed conduit below a flooring surface, comprising:
attaching a coupling to an end of the conduit;
retaining an electronic marker inside the coupling with a transmission axis of the electronic marker vertically-oriented and aligned with a longitudinal centerline of the conduit; and
securing a cap over the coupling to seal off the end of the conduit.

2. The method of claim 1, further comprising providing resilient filaments proximate a center of the cap which extend upwardly when the cap is secured over the coupling.

3. The method of claim 1 wherein the electronic marker is retained by a strip of flexible material which fits against an inner wall of the coupling under expansive tension.

4. The method of claim 1 wherein the electronic marker is retained by a strip of flexible material which fits against an inner wall of the conduit under expansive tension.

5. The method of claim 1 wherein the electronic marker is attached to an underside of a top wall of the cap.

6. The method of claim 1, further comprising cutting off a portion of an upper sidewall of the cap to adjust a height of the cap when secured on the conduit to a planned finished floor elevation.

7. The method of claim 1, further comprising:
applying a flooring material which overlies the cap secured to the coupling;
determining a location of the electronic marker using an electronic receiver;
removing flooring material at the location to reveal a top wall of the cap; and
removing a portion of the top wall of the cap to access the conduit.

8. An article for marking a pre-installed conduit below a flooring surface, comprising:
a coupling having a first end adapted for attachment to an end of the conduit, and having a second end;
a cap adapted for attachment to said second end of said coupling; and
an electronic marker retained inside said coupling having a transmission axis aligned with a common longitudinal centerline of said coupling and cap.

9. The article of claim 8, further comprising resilient filaments proximate a center of said cap which extend upwardly from a top wall of said cap.

10. The article of claim 8, further comprising a retainer which receives said electronic marker and removably fits against an inner wall of said coupling under expansive tension.

11. The article of claim 8 wherein said electronic marker is attached to an underside of a top wall of said cap.

12. The article of claim 8 wherein the electronic marker is a passive resonant marker.

13. The article of claim 8 wherein said cap includes an upper sidewall having a plurality of notches formed along an outer surface thereof to facilitate cutting said upper sidewall to a desired height.

14. The article of claim 8 wherein said cap includes a top wall having an upper surface with a notch formed in along said upper surface to facilitate cutting and removal of a portion of said top wall.

15. A below floor marker comprising:
a cylindrical coupling having a first end adapted for attachment to an end of a pipe stub, and having a second end;
a cylindrical cap adapted for attachment to said second end of said coupling;
resilient filaments proximate a center of said cap which extend upwardly from a top wall of said cap; and
an electronic marker attached to an underside of said top wall of said cap having a transmission axis aligned with a longitudinal centerline of said cap.

16. The below floor marker of claim 15 wherein said resilient filaments are attached to said electronic marker and extend through a hole in said top wall of said cap.

17. The below floor marker of claim 15 wherein said electronic marker is a passive marker having an elongate body.

18. The below floor marker of claim 15 wherein said electronic marker is a passive marker having a disk-shaped body.

19. The below floor marker of claim 15 wherein said cap includes an upper sidewall having a plurality of notches formed along an outer surface thereof to facilitate cutting said upper sidewall to a desired height.

20. The below floor marker of claim 15 wherein said cap includes a top wall having an upper surface with a notch formed in along said upper surface to facilitate cutting and removal of a portion of said top wall.
